(19) United States
(12) Patent Application Publication
(10) Pub. No.: US 2013/0197160 A1
(43) Pub. Date: Aug. 1, 2013

(54) COPOLYMER SYNTHESIZED FROM A MODIFIED GLYCOSAMINOGLYCAN (GAG) AND AN ANHYDRIDE FUNCTIONALIZED HYDROPHOBIC POLYMER

(71) Applicants: Susan P. James, Bellvue, CO (US); Rachael Kurkowski Oldinski, Seattle, WA (US)

(72) Inventors: Susan P. James, Bellvue, CO (US); Rachael Kurkowski Oldinski, Seattle, WA (US)

(73) Assignee: COLORADO STATE UNIVERSITY RESEARCH FOUNDATION (CSURF), Fort Collins, CO (US)

(21) Appl. No.: 12/596,583

(22) PCT Filed: Apr. 18, 2008
(86) PCT No.: PCT/US08/05054

§ 371 Date: Apr. 23, 2010

Related U.S. Application Data
(60) Provisional application No. 60/925,452, filed on Apr. 19, 2007.

(51) Int. Cl. C08F 255/02

(52) U.S. Cl. CPC C08F 255/02
USPC 525/54.2

(57) ABSTRACT

A new copolymer synthesized from a glycosaminoglycan (GAG) such as hyaluronan/hyaluronic acid (HA), chondroitin sulfates, derma tan sulfates, keratan sulfates, heparan sulfate, and heparin, and an anhydride functionalized hydrophobic polymer, i.e., any polyolefin which has been ‘functionalized’ (grafted onto the backbone or incorporated into the backbone) with anhydride functional groups, such as maleic anhydride-graft-polyethylene, (or, maleated polyethylene), maleic anhydride-graft-polystyrene, maleic anhydride-graft-polypropylene, etc. The functionalized polyolefin may be a polyolefin backbone to which the anhydride functional groups have been grafted, or otherwise incorporated with the backbone. Also, a unique synthesis technique combines a modified GAG with a graft polyolefin, resulting in a unique copolymer with its constituents by-and-large covalently bound to each other.

Commonly owned by the assignee-applicant hereof is U.S. Provisional Patent App. No. 60/925,452 filed 19 Apr. 2007 having at least one common inventor hereof, to which priority is claimed hereby.

### BACKGROUND OF THE INVENTION

### Technical Field

In general, the invention relates to polymers and polymeric systems, as well as associated techniques for synthesizing polymers. More-particularly, one aspect is directed to a new copolymer synthesized from a glycosaminoglycan (or simply, GAG) such as hyaluronan/hyaluronic acid (HA), chondroitin sulfates, dermatan sulfates, keratan sulfates, heparan sulfate, and heparin, and an anhydride functionalized hydrophobic polymer, i.e., any polyolefin which has been ‘functionalized’ (grafted onto the backbone or incorporated into the backbone) with anhydride functional groups, such as maleic anhydride-graft-polyethylene, (known, also, as maleated polyethylene), maleic anhydride-graft-polystyrene, maleic anhydride-graft-polypropylene, and so on. The unique synthesis technique also disclosed, to combine a modified GAG with a graft polyolefin, results in a unique copolymer with its constituents by-and-large covalently bound to each other. While GAG's such as hyaluronan, or hyaluronic acid, are generally non-melt-processable and biodegradable, hydrophobic polymers such as polyolefins to which anhydride functional groups have been grafted, e.g., maleic anhydride-graft-polyethylene/maleated polyethylene, are usually melt-processable and non-biodegradable.

Depending on the ratio and molecular weight of reactants (i.e., main constituents of copolymer), and graft percent of maleic anhydride onto the polyolefin, one aspect of the novel copolymer is an amphiphilic, biphasic construct consisting of a glycosaminoglycan (GAG) backbone and synthetic polymeric side chains; a second aspect comprises a synthetic polymer backbone with GAG side chains; and a third aspect comprises a continuous network of GAG and synthetic polymer, in which the synthetic polymer acts as crosslinks between different GAG chains or vice versa. The synthesis and characterization of the various identified aspects of the novel copolymer will be appreciated in connection with the technical discussion set forth, herein.

The anhydride functional groups grafted to the polyethylene chain are highly reactive compared to the hydrolyzed form of anhydrides, dicarboxylic acid. Hydrolysis occurs in the presence of water; for this reason, the reactions (details of which are included in the discussion identified as *EXAMPLE 01*) were performed in an inert atmosphere (e.g. dry medical grade nitrogen gas) and in non-aqueous solvents. Hyaluronan/hyaluronic acid (HA) is immiscible with non-polar (i.e. non-aqueous) solvents. Here, the glycosaminoglycan was first modified with, by way of example, an ammonium salt to decrease the polarity of the molecule (“modified glycosaminoglycan”); such a uniquely modified glycosaminoglycan was miscible with non-polar solvents (e.g. dimethyl sulfoxide). Other modified GAG's are contemplated; for example, the GAG may be modified with other paraffin ammonium cations dissociated from a salt selected from the group consisting of alkyltrimethylammonium chloride, alkylamine hydrochloride, alkylpyridinium chloride, alkyldimethylbenzyl ammonium chloride, alkyltrimethylammonium bromide, alkylamine hydrobromide, alkylpyridinium bromide, and alkyldimethylbenzyl ammonium bromide.

The anhydride graft polyethylene is miscible with xylenes at 135° C. The novel amphiphilic copolymer was washed and the modified glycosaminoglycan portion of the copolymer was reverted back to its unmodified chemical structure through hydrolysis.

### Applicant's Earlier Work in Synthesizing Hydrophobic-Hydrophilic Polymers

The assignee hereof also owns U.S. patent application Ser. No. 10/283,760 filed 29 Oct. 2002, James et al., entitled “Outer Layer having Entanglement of Hydrophobic Polymer Host and Hydrophilic Polymer Guest,” pub. No US 2003/0083433 on 1 May 2003 describing earlier design and research efforts of at least one applicant-inventor hereof, and is fully incorporated herein by reference to the extent it provides supportive technological information of the unique copolymer, and its synthesis, and is consistent with this technical discussion. The assignee hereof also owns PCT International App. No PCT/US2004/030666 filed 20 Sep. 2004, James et al., entitled “Hyaluronan (HA) Esterification via Acylation Technique for Moldable Devices,” international pub. No WO 2005/028632 A2 describing other earlier related research and development efforts of at least one applicant-inventor hereof.

### Glossary of Selected Miscellaneous Terms Included by Way of Background Reference, Only

A polymer is a substance composed of macromolecules, the structure of which essentially comprises the multiple repetition of units derived from molecules of low relative molecular mass. A monomer that is polymerized along with one or more other monomers creates a copolymer. A polyolefin (a/k/a more-recently, polyalkene) is a polymer produced from olefin, or alkene, as the monomer. For example, polyethylene is the polyolefin produced by polymerizing the olefin, ethylene. Polypropylene is the name given to the polyolefin which is made from propylene. Synthetic polymers encompass a huge list, including polyethylene, polypropylene, polystyrene (a polymer made from the monomer styrene), etc.

A copolymer is a polymer derived from a mixture of two or more starting compounds, or monomers; a copolymer exists in many forms in which the monomers are arranged to form different types, or structures. The properties of a polymer depends both on the type of monomers that make up the molecule, and how those monomers are arranged. For example, a linear chain polymer may be soluble or insoluble in water depending on whether it is composed of polar monomers or nonpolar monomers, and also on the ratio of the former to the latter. A graft copolymer can be synthesized by grafting one polymer onto a second polymer (i.e., rather than starting with mononmers, synthesis starts with pre-polymerized polymers that are then grafted together.)

The terminology that has developed to describe polymers refers to both the nature of the monomers as well as their relative arrangement within the polymer structure. The most-simple form of polymer molecule is a linear, or “straight chain”, polymer, composed of a single, linear backbone with pendant groups. A branched polymer molecule is composed of a main chain, or backbone, with one or more constituent side chains or branches (for example, branched polymers include star polymers, comb polymers, and brush polymers). If the polymer contains a side chain that has a different composition or configuration than the main chain, the polymer is considered a graft or grafted polymer. Anhydride graft polyethylene: is an example of a polyolefin that has been grafted with anhydride functional groups.

A crosslink suggests a branch point from which one polymer chain is covalently bound to another polymer chain, or a part of itself. A polymer molecule with a high degree of crosslinking is often referred to as a polymer network or an elastomer. If a there is a very high graft rate of a smaller (side chain) polymer molecule onto a larger (backbone) polymer molecule and there is a high graft rate and one side chain is grafted to more than one backbone molecule at a time, then the graft copolymer can form a polymer network.

Melt-processable: Those thermoplastic polymers that have a distinct thermodynamic, first order phase transition melting point that is below the degradation point of the polymer are considered melt-processable. Such a polymer will melt when heated, making it easier to form into different shapes, and when cooled down will recrystallize. Only the crystalline portion of the material actually melts, the amorphous regions do not. For most thermoplastic polymers, melting of the crystalline regions will make the polymer flow and thus make it thermally formable, if the melting point is well below the degradation point of the material.

Glycosaminoglycan (GAG), as used herein, is intended to include chemical structures known as hyaluronan, chondroitin sulfate, dermatan sulfate, keratan sulfate, heparan sulfate, and heparin; these are generally considered to be biodegradable molecules. A glycosaminoglycan is composed of a repeating disaccharide; that is, it has the structure -A-B-A-B-A-, where A and B represent two different sugars.

### SUMMARY DISCLOSURE OF THE INVENTION

One will appreciate the many distinguishable features of copolymer described herein from conventional products. Certain of the unique features of the invention, and further unique combinations of features—as supported and contemplated herein—provide a variety of advantages.

Briefly described, once again, the invention is directed to a novel copolymer synthesized from a glycosaminoglycan (e.g. hyaluronan, chondroitin sulfate, dermatan sulfate, keratan sulfate, heparan sulfate, heparin), and an anhydride functionalized hydrophobic polymer (such as any melt-processable polyolefin which has been grafted, or otherwise incorporated, with anhydride functional groups, e.g. anhydride graft polyethylene). The copolymer includes an amphiphilic, biphasic construct composed of a glycosaminoglycan (GAG) and a synthetic polymer. Also characterized is an associated novel process for synthesizing the copolymer.

One aspect of the invention is directed to a new copolymer synthesized from a glycosaminoglycan (GAG) such as hyaluronan, or hyaluronic acid (HA), chondroitin sulfates, dermatan sulfates, keratan sulfates, heparan sulfate, and heparin, and an anhydride functionalized hydrophobic polymer, i.e., any polyolefin which has been ‘functionalized’ (grafted onto the backbone or incorporated into the backbone) with anhydride functional groups; many such functionalized hydrophobic polymers are contemplated, such as maleic anhydride-graft-polyethylene (or simply, maleated polyethylene), maleic anhydride-graft-polystyrene, maleic anhydride-graft-polypropylene, and so on. The unique synthesis technique described herein to combine a modified GAG with an anhydride functionalized hydrophobic polymer, such as a graft polyolefin, results in a unique copolymer with its constituents by-and-large covalently bound to each other. One aspect of the novel copolymer is an amphiphilic, biphasic construct consisting of a glycosaminoglycan (GAG) backbone and synthetic polymeric side chains; a second aspect comprises a synthetic polymer backbone with GAG side chains; and a third aspect comprises a continuous network of GAG and synthetic polymer.

### BRIEF DESCRIPTION OF DRAWINGS

For purposes of illustrating the innovative nature plus the flexibility of design and versatility of the new copolymer and associated technique for synthesizing, figures are included. One can readily appreciate the advantages as well as novel features that distinguish the novel copolymer from conventional polymers and polymeric synthesis techniques. The figures as well as any incorporated technical materials have been included to communicate the features of applicants' innovations by way of example, only, and are in no way intended to limit the disclosure hereof. Briefly, consecutively labeled figures include:

FIG. 1(a) is a chemical structure of hyaluronan/hyaluronic acid, HA, at 10.

FIG. 1(b) depicts a chemical structure of an anhydride graft polyethylene. The polyethylene chain and anhydride functional group are labeled for reference.

FIG. 2 is a digital photographic-depiction of an experimental setup that may be used for carrying out a reaction, preferably carried out in an inert atmosphere, for synthesis of *EXAMPLE 01* graft copolymer(s).

FIG. 3(a) is a scanning electron microscopy (SEM) image of the synthesized graft copolymer.

FIG. 3(b); graphically depicts data relating to compression molding cycle for HA-co-HDPE and crosslinked (“XL”) HA-co-HDPE specimens (85 and 98 weight % HA) in connection with *EXAMPLE 01* graft copolymer(s); one curve depicts how temp varied with time, the other curve shows pressure variation with time.

FIG. 4(a) graphically depicts results from a differential scanning calorimetric scan overlay of anhydride graft polyethylene (refluxed MA-g-HDPE; 0.3% MA, 121.5 kg/mol), the glycosaminoglycan (HA; 1.5 MDa), and various graft copolymers with specific glycosaminoglycan weight percentages (10 molar=85% HA, 1 molar=98% HA).

FIG. 4(b) graphically depicts results from a differential scanning calorimetric scan of HA-co-HDPE fabricated from MA-g-HDPE with a molecular weight of 15 kg/mole (50% HA).

FIG. 5 graphically depicts results from a thermal gravimetric analysis scan of the graft copolymer, a blend of the anhydride graft polyethylene and glycosaminoglycan (MA-g-HDPE and HA), and its constituents. The TGA scans show that the esterification reaction between HA and HDPE affects the degradation profiles of the two constituent polymers. This verifies covalent bond formation between HA and MA-g-HDPE in the copolymer.

FIG. 6 is a high-level flow diagram depicting features of a technique 20 for synthesizing a copolymer of the invention.

FIG. 7: chemical structure 30 of a novel copolymer synthesized accordingly.

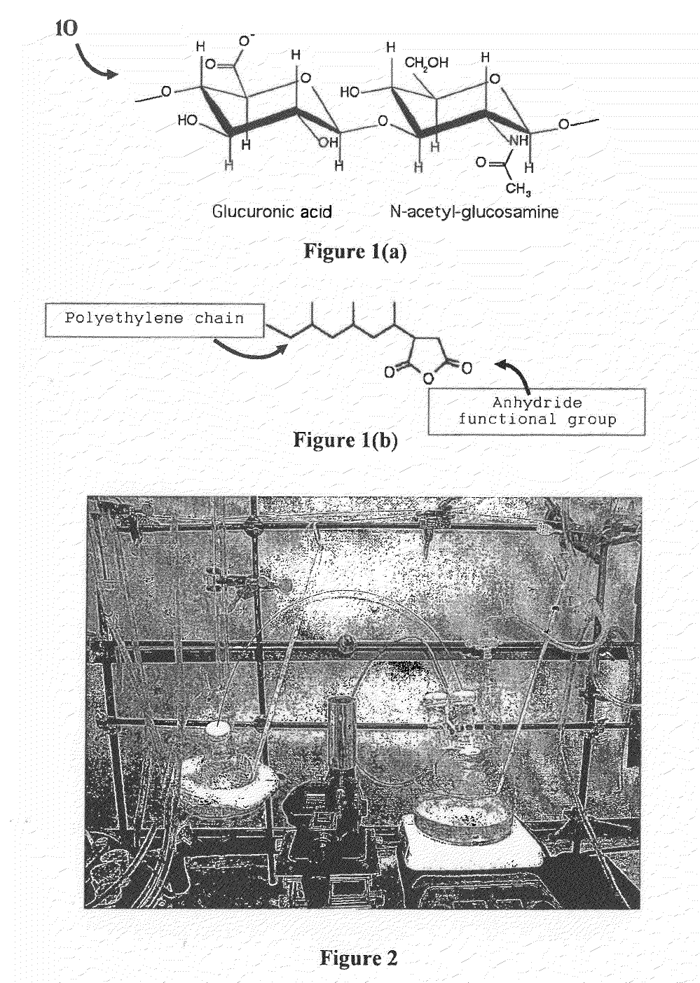

### DESCRIPTION DETAILING FEATURES/MODE OF THE INVENTION

By viewing the figures depicting representative embodiments—further details included and labeled *EXAMPLE 01*—of the unique copolymer and process to synthesize same, one can further appreciate the unique nature of core as well as additional and alternative features that are within the spirit and scope of this technical discussion. Reference has been made to various features—those depicted in the figures and diagrams (including those incorporated within an *EXAMPLE*)—by way of back-and-forth reference and association.

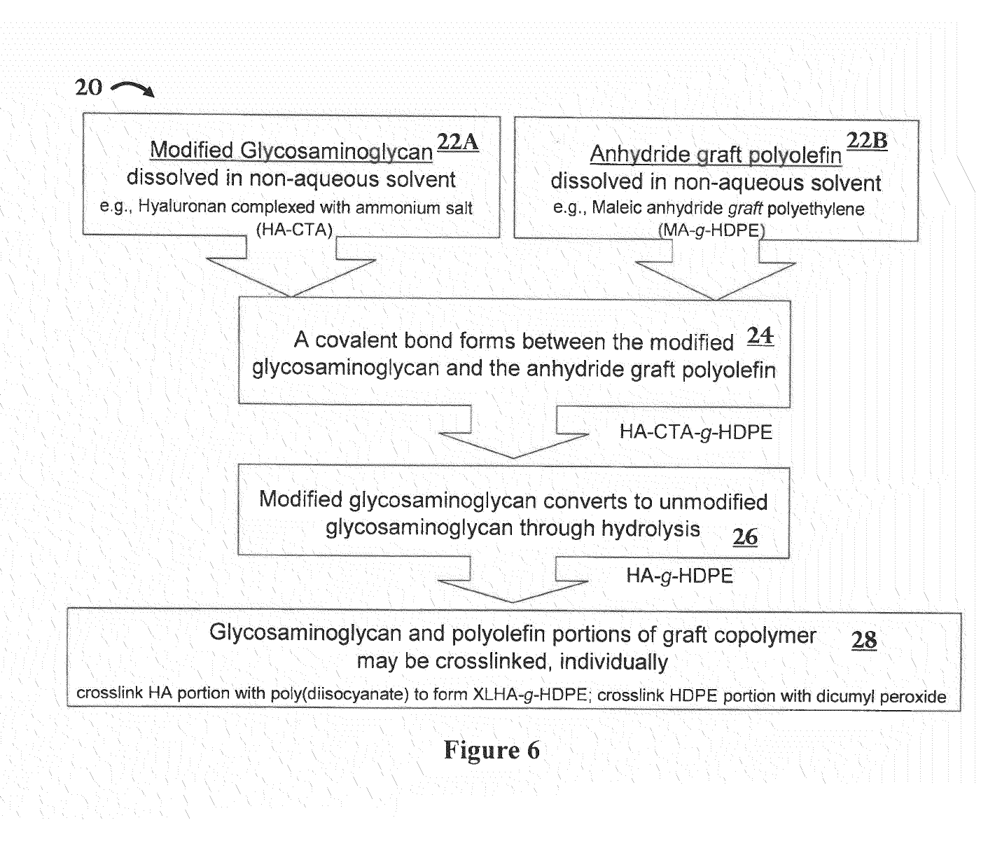

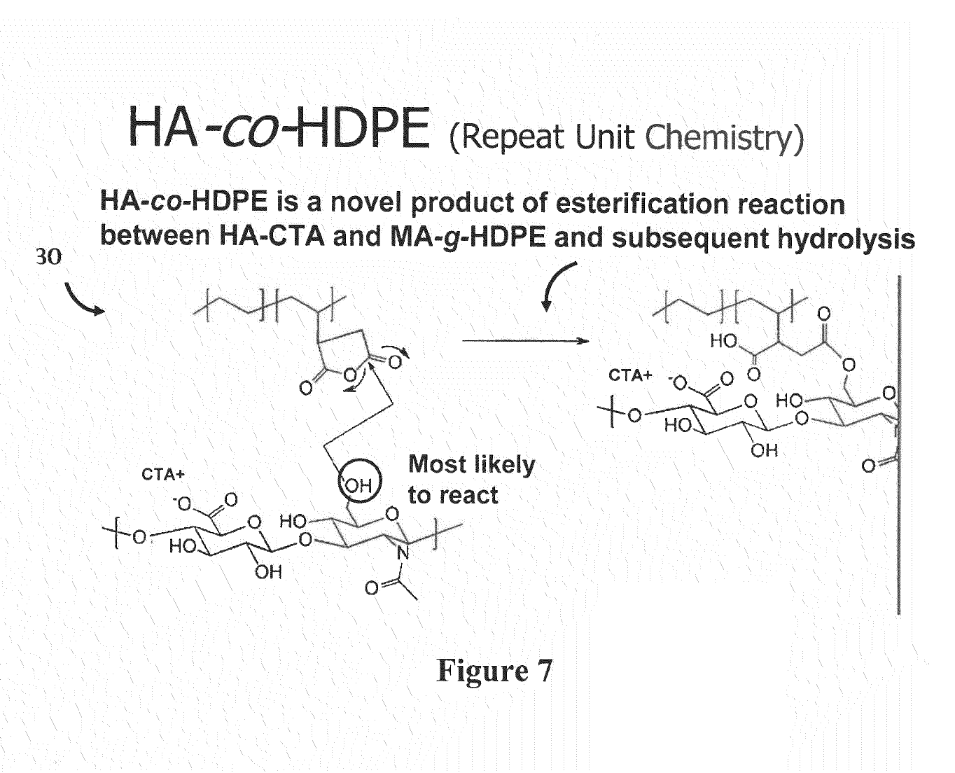

Turning, first, to FIG. 6: the copolymer synthesis technique represented at 20 joins a modified glycosaminoglycan dissolved in non-aqueous solvent 22A, e.g., hyaluronan complexed with ammonium salt (HA-CTA), with an anhydride graft polyethylene also having been dissolved in a non-aqueous solvent 22B, e.g., maleic anhydride graft polyethylene (MA-g-HDPE). The anhydride functional groups grafted to the polyethylene chain are highly reactive compared to the hydrolyzed form of anhydrides, dicarboxylic acid. Since hydrolysis occurs in the presence of water, the copolymer reaction must be performed in an inert atmosphere (e.g. dry industrial nitrogen or argon gas) and in non-aqueous solvents; see, also FIG. 2. A covalent bond forms between the modified glycosaminoglycan and the anhydride graft polyethylene (24) forming the structure HA-CTA-co-HDPE (see, FIG. 7 at 30).

Once the copolymer reaction is complete, hydrolysis is purposely performed converting the modified glycosaminoglycan portion of the copolymer back to ‘unmodified’ glycosaminoglycan resulting in the GAG-polyolefin copolymer (in this specific example, HA-co-HDPE, box 26). Due to hyaluronan's immiscibility with non-polar (i.e. non-aqueous) solvents, the glycosaminoglycan was first modified with an ammonium salt to decrease the polarity of the molecule (i.e. modified glycosaminoglycan) 22A; once this was achieved the modified glycosaminoglycan was miscible with non-polar solvents (e.g. dimethyl sulfoxide). The anhydride graft polyethylene is miscible with xylenes at above approximately 100° C. As mentioned, the novel amphiphilic copolymer was washed and the modified glycosaminoglycan was reverted back to its unmodified chemical structure through hydrolysis (box 26, FIG. 6; see also FIG. 7). The glycosaminoglycan or polyolefin portions of the graft copolymer are now available for further processing (box 28), e.g, may be crosslinked. This may be performed ‘individually’ as is suggested at 28: crosslink HA portion with poly(diisocyanate) to form XLHA-g-HDPE; and crosslink HDPE portion with dicumyl peroxide.

A wide range of applications of the new copolymer are contemplated, to include a variety of devices and procedures, including but not limited to: total joint arthroplasty (as part or all of implant), hemi-arthroplasty, partial hemi-arthroplasty, scaffold for tissue engineering (specifically articular cartilage), meniscus replacement, catheters, condoms, cosmetics, wound dressing, ear tubes for chronic ear infections, carrier for drugs, demineralized bone matrix and bone morphogenetic proteins, bone defect filler, cosmetic surgery, maxio-facial reconstructions, non fouling coating for catheters, tissue engineering scaffold, anti adhesive film or coating, soft tissue augmentation—meniscus, cartilage, spinal disc, temporo-mandibular disc replacement, low friction coating on instruments/devices, wound covering (nonstick bandage, etc), viscosupplementation, eye surgery lubricant, etc.

### *Example 01*

Synthesis of HA-CTA-Co-HDPE and its Hydrolysis to Yield HA-co-HDPE (reaction conditions given for 98 and 85% HA HA-CTA-co-HDPE with HA molecular weight of 1.5 MDa, and 0.3% MA (graft percent) MA-g-HDPE wherein the HDPE has a molecular weight of 121.5 kg/mol)

Complexation methods for sodium HA with CTAB are known. See, by way of further example: Zhang, M. and James, S. P.: Novel Hyaluronan Esters for Biomedical Applications, Rocky Mountain Bioengineering Symposium, Biomedical Sciences Instrumentation 238, 2004; Zhang, M. and James, S. P.: Silylation of hyaluronan to improve hydrophobicity and reactivity for improved processing and derivatization, Polymer 46:3639, 2005; and Zhang, M. and James, S. P.: Synthesis and properties of melt-processable hyaluronan esters, Journal of Materials Science: Materials in Medicine 16:587 (2005).

In U.S. patent application Ser. No. 10/283,760, James et al., “Outer Layer having Entanglement of Hydrophobic Polymer Host and Hydrophilic Polymer Guest,” pub. No US 2003/0083433 (mentioned above) on 1 May 2003, such complexes of HA were discussed:

—Begin QUOTED text—

### Example 2

(1) Reaction of HA with long-chain aliphatic quaternary ammonium salts (9N⁺). Polyanions, such as HA, combined with certain organic cations, such as paraffin chain ammonium (QN+) ions, produces a precipitable complex. The complex is a true salt of the polyacid and quaternary base. HA was modified with long-chain aliphatic ammonium salts, to improve its solubility in organic solvents. Combination of QN+ with polyannions occurs in those pH ranges in which the polyannions are negatively charged. The reaction between HA and ammonium cations in water can be expressed:

HA⁻-Na⁺+QN⁺A⁻→HA⁻-QN⁺↓+Na⁺A⁻
where HA⁻-Na⁺ is the sodium salt of hyaluronic acid; HA⁻-QN⁺ is the precipitable complex between HA carboxylic polyanion and long chain paraffin ammonium cations. HA⁻-QN⁺ (HA-CPC HA-CTAB) complexes were used. The complexes (HA⁻-QN⁺) precipitated from HA aqueous solution are soluble in concentrated salt solutions. so HA can be recovered from its insoluble complexes. Ammonium salts used were: cetyltrimethylammonium bromide monohydrate (MW: 358.01) (CTAB) and cetylpyridinum chloride (M.W. 364.46) (CPC).

—End QUOTED text—

Briefly, for this *EXAMPLE 01*, aqueous solutions of 0.2% (w/v) sodium HA and 1.0% (w/v) CTAB were mixed at room temperature to precipitate the HA-CTA. The precipitate was centrifuged, washed with H2O several times to remove Na⁺ Br⁻ salt, and vacuum dried at room temperature for 72 hours (or until no change in weight was observed). The molecular weight of HA-CTA was determined to be 2.48×10⁶ Da. HA-CTA and MA-g-HDPE, are the two constituents of the graft copolymer HA-co-HDPE, and their structures are shown below; however, the MA-g-HDPE used in this study was HDPE with MA grafted (0.36 weight %) randomly along the HDPE backbone, unlike the structure shown below (bottom chemical structure), where it appears such that the MA is grafted at the ‘tail-end’ of the HDPE chains:

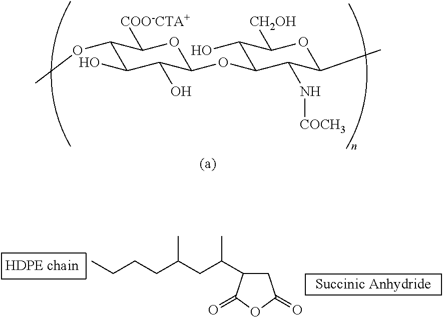

Chemical structures: top structure is of HA-CTA; and bottom is of MA-g-HDPE.

A 0.1% (w/v) solution of MA-g-HDPE in xylenes was refluxed for two hours at 135° C. under a dry N₂ atmosphere ensuring all of the MA-g-HDPE had gone into solution. HA-CTA was dissolved in DMSO at 80° C. (a 0.5% (w/v) solution). The MA-g-HDPE solution was added to the HA-CTA solution via a heated cannula (FIG. 2) under dry N₂ flow (see chemical structures diagrammed immediately below):

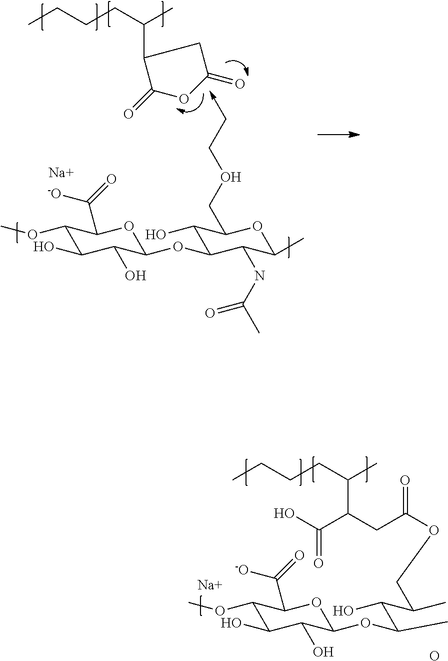

Chemical structures of: (left-side) HA-CTA; and (right-side) MA-g-HDPE.

After 24 hours the viscous gel product and supernatant were vacuum dried at 50° C. for 72 hours; due to the complexity of evaporating off DMSO, only the xylenes portion of the supernatant was removed via vacuum drying. The DMSO was removed through hydrolysis process since it is miscible with both H2O and ethanol.

The amount (g) of HA-CTA and MA-g-HDPE used in the reaction, as determined by amount of the 0.1% (w/v) solution of MA-g-HDPE in xylenes and 0.5% (w/v) solution of HA-CTA in DMSO used in the reaction, can be adjusted to synthesize copolymer products with different theoretical weight percentages of HA and HDPE. The glycosaminoglycan weight percentage of the copolymer was calculated prior to the reaction assuming 100% reaction between constituents and complete substitution of the CTA+ with Na+ during hydrolysis, which determined the required amount of MA-g-HDPE and HA-CTA to be used in the reaction (see, also, *EXAMPLE 02* of Prov. App. No. 60/925,452, section 3.2.2 for general reference).

Using techniques similar to those described above, multiple theoretical weight percentages (40-98%) of the glycosaminoglycan to polyolefin, in the novel amphiphilic copolymer, were fabricated in order to observe the effects of different weight percentages of the glycosaminoglycan. The copolymer was also fabricated from glycosaminoglycans with various molecular weights (640 kDa and 1.5 Da) and functionalized polyolefins with various anhydride graft (i.e., weight) percentages (0.3 and 3.0%) and various molecular weights (15 kg/mol and 121.5 kg/mol). Chemical crosslinking of the glycosaminoglycan portion of the graft copolymer (see, also, FIG. 6 at 28) was accomplished via a poly(hexamethylene diisocyanate) crosslinker after hydrolysis.

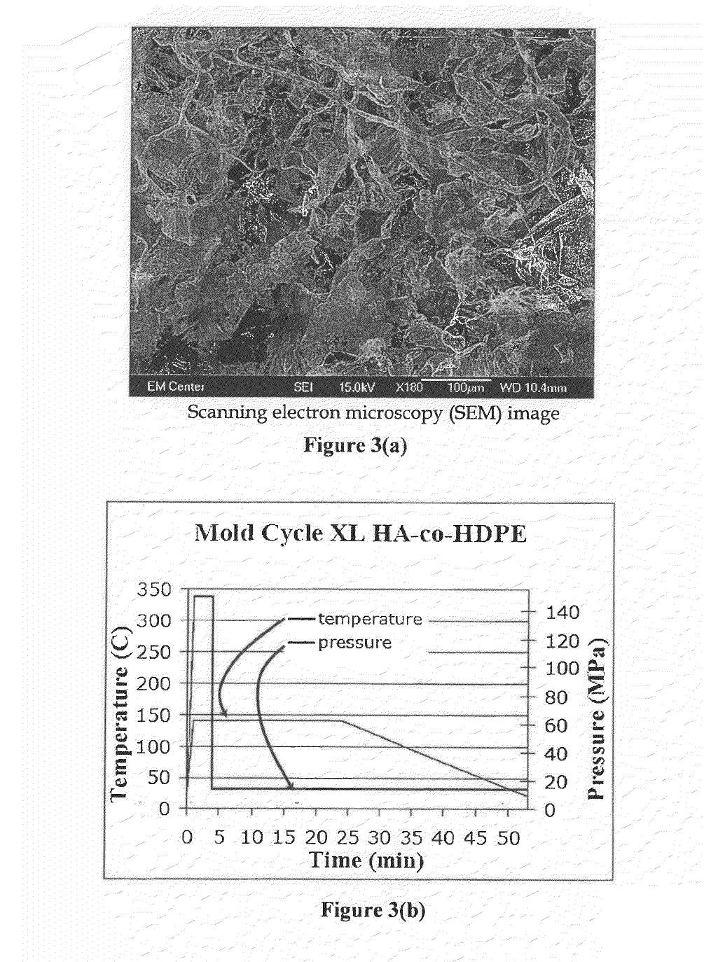

To determine if the graft copolymer and the crosslinked graft copolymer powders could be compression molded, powder was placed in a stainless steel mold (such molds are commonplace, and can be shaped with a cylindrical inner cavity for molding the material in compression). The compression molding cycles for both the graft copolymer and the crosslinked (XL) graft copolymer were identical; refer to FIG. 3(b), also labeled in *EXAMPLE 02* of Prov. App. No. 60/925,452 as FIG. 3.4: “Compression molding cycle for HA-co-HDPE and XL HA-co-HDPE specimens (85 and 98 weight % HA)” depicting how temp and pressure varied over time. The melt soak temperature was approximately 10-15° C. above the average melt temperature of the graft copolymer, which was deduced from differential scanning calorimetry results.

The reaction between the modified glycosaminoglycan and the anhydride graft polyethylene was carried out in an inert atmosphere, forming the novel graft copolymer. FIG. 2 depicts a reaction test set-up configuration for *EXAMPLE 01* graft copolymer synthesis. The reaction yields were approximately 95%. The resulting product was a swollen gel network (encapsulating the non-aqueous solvents) for higher weight percents of HA and was a melt-processable powder for lower weight percents of HA. A white, fluffy, porous powder was generated via hydrolysis, in which modified glycosaminoglycan graft copolymer converted to an unmodified glycosaminoglycan graft copolymer. FIG. 3 is a scanning electron microscopy (SEM) image of the converted graft copolymer in powder form (FIG. 6, box 26).

Upon hydration with water, the graft copolymer behaved like a hydrogel; the liquid prevented the polymer network (i.e. physically and chemically crosslinked mesh made up of polymer chains) from collapsing into a compact mass, and the network retained the liquid. The non-crosslinked graft copolymer was completely dispersed, but not dissolved, in water at room temperature after several hours; the crosslinked graft copolymer behaved qualitatively similar to the non-crosslinked graft copolymer. The graft copolymers both dispersed, but did not dissolve, in either or xylenes at room temperature. The insolubility of the copolymer indicates that a reaction did take place to form covalent bonds between the water soluble HA and xylenes soluble HDPE. The insoluble nature of the unique copolymer poses a challenge when attempting to characterize the graft copolymer and crosslinked graft copolymer using standard, conventional analytical techniques. Both a graft copolymer that is unmodified and a crosslinked graft copolymer are not soluble in any typical organic solvent, which hinders the use of solution dependent polymer characterization methods. The lack of solubility precludes the measurement of molecular weight, for example.

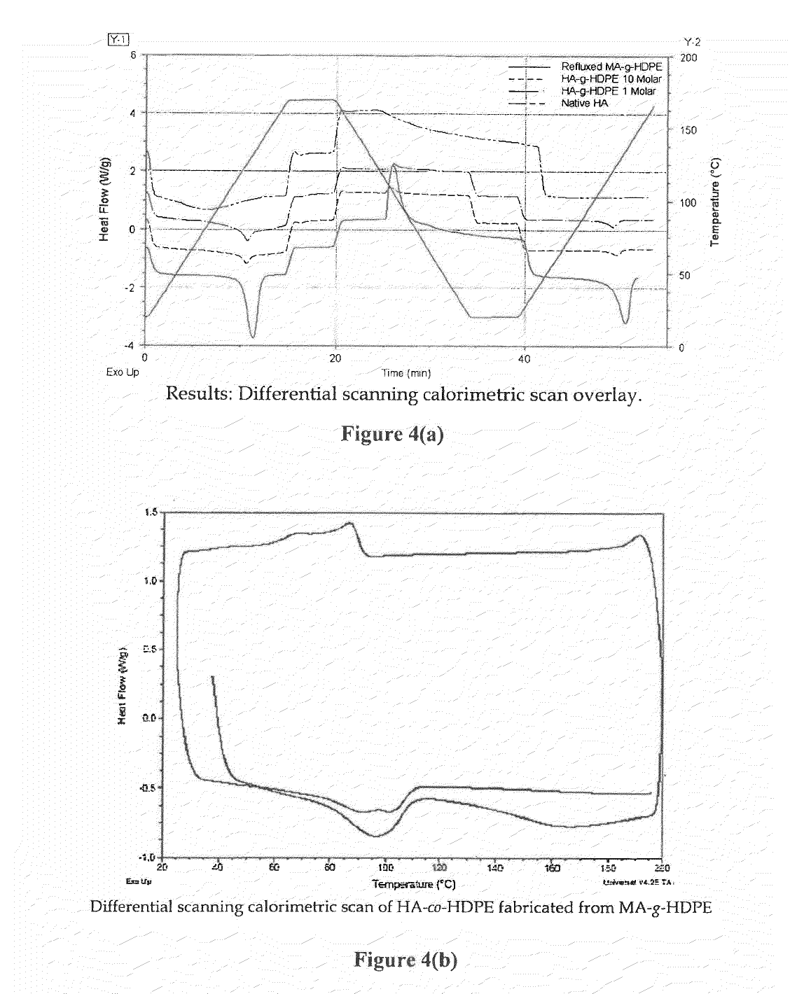

FIG. 4(a) graphically depicts results from a differential scanning calorimetric scan overlay of anhydride graft polyethylene (refluxed MA-g-HDPE; 0.3% MA, 121.5 kg/mol), the glycosaminoglycan (HA; 1.5 MDa), and various graft copolymers with specific glycosaminoglycan weight percentages (10 molar=85% HA, 1 molar=98% HA). FIG. 4(b) graphically depicts results from a differential scanning calorimetric scan of HA-co-HDPE fabricated from MA-g-HDPE with a molecular weight of 15 kg/mole (50% HA). The introduction of HA lowered the melt temperature (peak temperature value) and percent crystallinity (peak area) of the anyhydride graft polyethylene. The changes in the peak values and areas, representing changes in the crystalline domains of the copolymer compared to the two constituents indicate covalent bonding between the HA to MA-g-HDPE (i.e., indicate copolymer formation). As described above, the melt temperature of the different graft copolymers was used to develop the compression molding cycle for the graft copolymers.

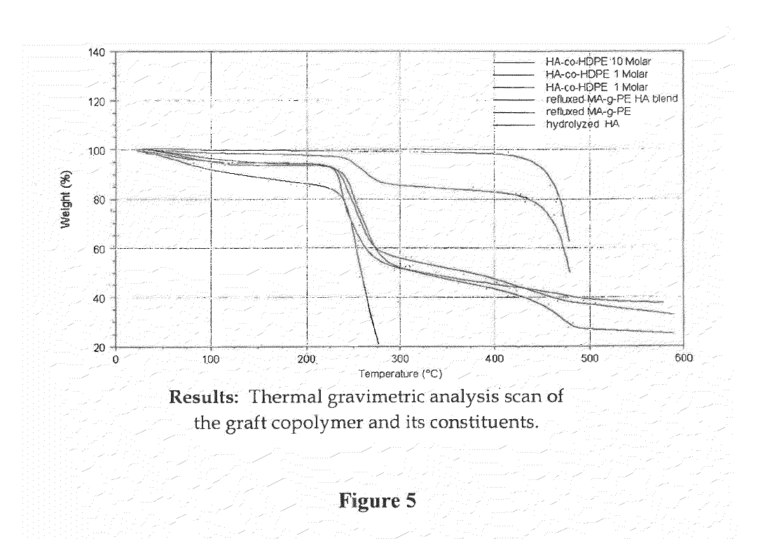

Thermogravimetric analysis scans were also analyzed and the degradation temperature of each polymer was determined: FIG. 5 graphically depicts results from a thermal gravimetric analysis scan of the graft copolymer, a blend of the anhydride graft polyethylene and glycosaminoglycan (MA-g-HDPE and HA), and its constituents. The TGA scans show that the esterification reaction between HA and HDPE affects the degradation profiles of the two constituent polymers, verifying covalent bond formation between HA and MA-g-HDPE in the copolymer. From the thermogravimetric analysis data, the experimental weight percentages of the constituents can be compared to theoretical weight percentage calculations performed prior to the reaction taking place. Table 2 compares the values for theoretical and experimental weight percentages.

TABLE 2
Comparison between theoretical constituent weight ratios and
the weight ratios calculated from TGA data for HA-co-HDPE.

| Theoretical | TGA |
|---|---|
| HA:HDPE | HA:HDPE |
| 30:70 | 42:53 |
| 40:60 | 37:59 |
| 50:50 | 33:67 |
| (HA, 1.4 × 10⁶ Da) | |
| 50:50 | 35:65 |
| (HA, 6.4 × 10⁵ Da) | |
| 60:40 | 56:44 |
| (HA, 1.4 × 10⁶ Da) | |

To further verify that the resultant copolymer was the product of the anhydride graft polyethylene and the HA-CTA, two negative control (also referred to as ‘sham’) reactions were performed. The first sham/control reaction was run, exactly as described above, but with plain high density polyethylene (HDPE) in the place of the anhydride graft polyethylene. In other words, in the absence of air and water, plain HDPE was refluxed in xylenes at ˜145° C. and then added to the HA-CTA in DMSO at ˜80° C.

A second sham/control reaction was carried out between anhydride graft polyethylene in xylenes and DMSO with no HA-CTA.

Neither sham/control reaction formed a copolymer. The sham reactions did not form a gel product as occurs with the anhydride polyethylene/HA-CTA reaction according to the processes depicted in FIGS. 6 and 7. When the solvents were evaporated, two distinct phase-separated powders remained from the first sham reaction and a single powder (anhydride graft polyethylene) remained from the second sham reaction. In other words, no copolymer was formed.

The non-degradable hydrophobic portion of the novel copolymer may also be chemically crosslinked via irradiation (gamma or e-beam), silane or peroxides (e.g. dicumyl peroxide [(bis(1-methyl-1-phenylethyl) peroxide], and benzyl peroxide [2,5-Dimethyl-2,5-di-(tert-butyl-peroxy) hexyne-3 peroxide], 2,5-dimethyl-2,5-bis(tert-butylperoxy)-3-hexyne), which would serve to increase the mechanical properties of the graft copolymer and alter the physical (rheological) properties of the graft copolymer.

While certain representative embodiments and certain details have been shown for the purpose of illustrating the invention, those skilled in the art will appreciate that various modifications, whether specifically or expressly identified herein, may be made to these representative embodiments without departing from the novel core teachings or scope of this technical disclosure. Accordingly, all such modifications are intended to be included within the scope of the claims. Whether the commonly employed phrase “comprising the steps of” may be used in a method claim, the applicant(s) does not intend to invoke any law in a manner that unduly limits rights to its innovation. Furthermore, in any claim that is filed herewith or hereafter, any means-plus-function clauses used, or later found to be present, are intended to cover at least all structure(s) described herein as performing the recited function and not only structural equivalents but also equivalent structures.

We claim:

1. A copolymer synthesized from a first constituent comprising a modified glycosaminoglycan, and a second constituent comprising an anhydride functionalized hydrophobic polymer; the first constituent being covalently bound to the second constituent.

2. The copolymer of claim 1 wherein: the glycosaminoglycan is selected from the group consisting of hyaluronan, chondroitin sulfates, dermatan sulfates, keratan sulfates, heparan sulfate, and heparin; and the second constituent comprises a polyolefin which has been functionalized with anhydride functional groups.

3. The copolymer of claim 2 wherein the second constituent is selected from the group consisting of: maleic anhydride-graft-polyethylene, maleic anhydride-graft-polypropylene, and maleic anhydride-graft-polystyrene.

4. The copolymer of claim 2 wherein the functionalized polyolefin comprises a polyolefin backbone to which the anhydride functional groups have been grafted.

5. The copolymer of claim 2 wherein the functionalized polyolefin comprises a polyolefin backbone into which the anhydride functional groups have been incorporated.

6. The copolymer of claim 1 wherein the first constituent comprises a glycosaminoglycan modified with a paraffin ammonium cation dissociated from a salt selected from the group consisting of alkyltrimethylammonium chloride, alkylamine hydrochloride, alkylpyridinium chloride, alkyldimethylbenzyl ammonium chloride, alkyltrimethylammonium bromide, alkylamine hydrobromide, alkylpyridinium bromide, and alkyldimethylbenzyl ammonium bromide.

7. A method of synthesizing a copolymer, the method comprising: covalently bonding a first constituent comprising a modified glycosaminoglycan, with a second constituent comprising an anhydride functionalized hydrophobic polymer.

8. The method of synthesizing of claim 7 wherein: the glycosaminoglycan is selected from the group consisting of hyaluronan, chondroitin sulfates, dermatan sulfates, keratan sulfates, heparan sulfate, and heparin; and the second constituent comprises a polyolefin which has been functionalized with anhydride functional groups.

9. The method of synthesizing of claim 8 wherein the functionalized polyolefin comprises a polyolefin backbone to which the anhydride functional groups have been grafted.

10. The method of synthesizing of claim 8 wherein the functionalized polyolefin comprises a polyolefin backbone into which the anhydride functional groups have been incorporated.

11. The method of synthesizing of claim 7 wherein the second constituent is selected from the group consisting of: maleic anhydride-graft-polyethylene, maleic anhydride-graft-polypropylene, and maleic anhydride-graft-polystyrene.

12. The method of synthesizing of claim 7 wherein the first constituent comprises a glycosaminoglycan modified with a paraffin ammonium cation dissociated from a salt selected from the group consisting of alkyltrimethylammonium chloride, alkylamine hydrochloride, alkylpyridinium chloride, alkyldimethylbenzyl ammonium chloride, alkyltrimethylammonium bromide, alkylamine hydrobromide, alkylpyridinium bromide, and alkyldimethylbenzyl ammonium bromide.
